(19) United States
(12) Patent Application Publication
(10) Pub. No.: US 2008/0066125 A1
(43) Pub. Date: Mar. 13, 2008

(54) Method and system for content distribution

(75) Inventors: Zhi Li, San Ramon, CA (US); Canhui Ou, Danville, CA (US); Wayne Robert Heinmiller, Elgin, IL (US); Steve Sposato, Lafayette, CA (US); Julia Hein, Huntley, IL (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/510,027

(22) Filed: Aug. 25, 2006

(51) Int. Cl. H04N 7/173

(52) U.S. Cl. 725/97; 725/92; 725/114

(57) ABSTRACT

A method and system for content distribution. A scheduler for determining content to be sent to one or more devices and for creating a schedule to transmit the content. A content server for accessing content to be sent to one or more devices. A delivery modules to effectuate delivery of the content via at least one transmission protocol to the one or more devices according to the schedule.

### FIELD

This application relates to a method and system for content distribution, and more specifically to systems and methods for providing content to user devices.

### BACKGROUND

Content providers deliver content via broadcasts to a number of users and/or deliver content via on-demand processing based on requests received and content availability. When providing content at the request of a user, the content is typically provided to the user in either real time or at a slight delay associated with the transmission and/or reproduction of the content. When many users are making requests to a same content provider for on-demand content and/or are having on-demand requests filled simultaneously, such as during peak periods, the servers of the content provider may become unavailable, run slow, and/or fail to satisfy the requests of some of the users. In addition, network congestion during the peak periods may cause glitches and service degradation.

### BRIEF DESCRIPTION OF DRAWINGS

Embodiments are illustrated by way of example and not limitation in the figures of the accompanying drawings, in which like references indicate similar elements and in which:

FIG. 1 is a block diagram of a system for distributing content to user devices in accordance with an example embodiment;

FIG. 2 illustrates a diagrammatic representation of an Internet Protocol Television (IPTV) system that may be used to provide video content used in an example embodiment;

FIG. 3 is a block diagram of a system for scheduling and delivering content through a network in accordance with an example embodiment;

FIG. 4 is a block diagram of a system for scheduling and delivering content through a network in accordance with an example embodiment;

FIG. 5 is a block diagram of a system for scheduling and delivering content through a network in accordance with an example embodiment;

FIG. 6 is a block diagram of a system for scheduling content in accordance with an example embodiment;

FIG. 7 is a flowchart illustrating a method in accordance with an example embodiment for providing content in response to a content request;

FIG. 8 is a flowchart illustrating a method in accordance with an example embodiment for scheduling content;

FIG. 9 is a flowchart illustrating a method in accordance with an example embodiment for delivering content;

FIG. 10 is a flowchart illustrating a method in accordance with an example embodiment for requesting and accessing content;

FIG. 11 is a flowchart illustrating a method in accordance with an example embodiment for requesting and accessing content; and

FIG. 12 illustrates a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

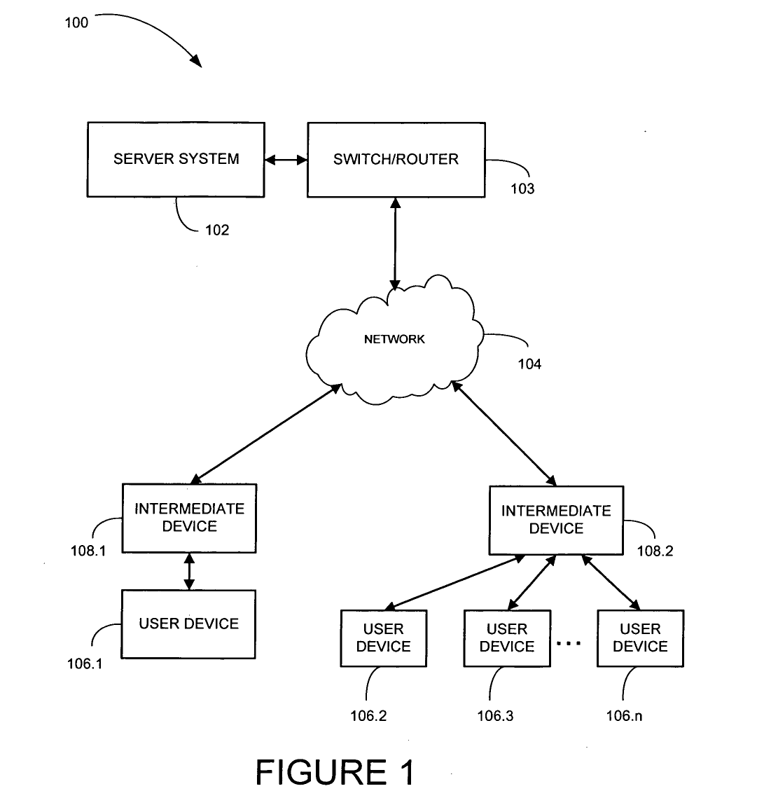

Referring to FIG. 1, an example embodiment of a system 100 for distributing content to user devices is illustrated. The system 100 may include a server system 102 to transmit content over a network 104 through a switch/router 103.

In an example embodiment, the content may include media such as video content in the form of a movie or television program and digital music content such as an MP3 file. In an example embodiment, the content may include data such as a video game and/or patch file. In an example embodiment, the content may include informational content. It should be appreciated that other types of content may be used with the system 100.

The server system 102 may include one or more content servers for providing content such as one or more video on demand (VOD) servers, video content servers, application servers, music servers and the like.

The switch/router 103 may route data, such as the content and content requests, through the network 104. The network 104 may include a private network, a public network such as the Internet, an access network, or combinations of the private network, the public network and/or the access network. The network 104 may provide data to and receive data from devices such as the intermediate devices 108.1, 108.2.

A non-networked intermediate device 108.1 may provide the content to a user device 106.1 and transmit content requests to the server system 102. Examples of the non-networked intermediate device 108.1 include set top boxes (STBs), digital video recorders (DVRs), computing systems, and the like.

A networked intermediate device 108.2 may provide the content to a number of user devices 106.2-106.n and transmit content requests to the server system 102. Examples of the networked intermediate device 108.2 may include STBs, DVRs, computing systems, servers and the like.

In an example embodiment, the networked intermediate device 108.2 may include a STB and the user devices 106.2-106.n may include televisions. For example, the STB may distribute received content to multiple televisions within a home or connected to a network.

In an example embodiment, the intermediate devices 108.1, 108.2 may be located in a single location, such as a home or a place of business occupied by an operator of the user devices 106.1-106.n.

In an example embodiment, the intermediate devices 108.1, 108.2 may transmit received content to other devices including additional intermediate devices 108.1, 108.2. For example, the intermediate devices 108.1, 108.2 may retain received content.

The user devices 106.1-106.n may include televisions, computing systems, digital media players, gaming devices, mobile phones, personal digital assistants (PDAs) and the like. For example, the user devices 106.1-106.n may include software, hardware or a combination thereof.

In an example embodiment, the user device 106.1 may be combined with the intermediate device 108.1 in a combination device.

In an example embodiment, the intermediate devices 108.1, 108.2 may include security controls to restrict access to certain content, such as for a user of the user devices 106.1-106.n. For example, a parent may restrict a child's access to certain content on the intermediate device 108.1 by use of the security controls.

In an example embodiment, the intermediate devices 108.1, 108.2 may include a content library. For example, the content library may retain content for the respective user devices 106.1-106.n associated with the intermediate devices 108.1, 108.2, or respective users of the user devices 106.1-106.n such that each user of the user device 106 has an individual content library and/or a shared content library.

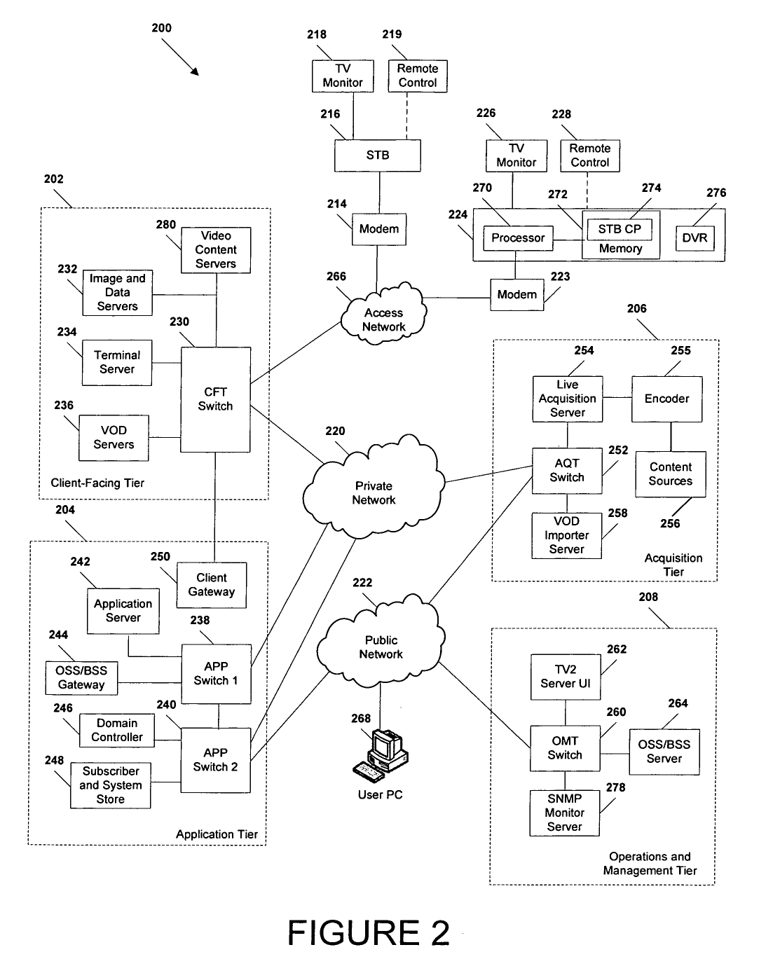

Referring to FIG. 2, an illustrative embodiment of an Internet Protocol Television (IPTV) system that may be used to provide content in the form of video content is illustrated and is generally designated 200. However, the use of other systems for providing video content and non-video content are also contemplated.

As shown, the system 200 can include a client facing tier 202, an application tier 204, an acquisition tier 206, and an operations and management tier 208. Each tier 202, 204, 206, 208 is coupled to a private network 220; to a public network 222, such as the Internet; or to both the private network 220 and the public network 222. For example, the client-facing tier 202 can be coupled to the private network 220. Further, the application tier 204 can be coupled to the private network 220 and to the public network 222. The acquisition tier 206 can also be coupled to the private network 220 and to the public network 222. Additionally, the operations and management tier 208 can be coupled to the public network 222.

As illustrated in FIG. 2, the various tiers 202, 204, 206, 208 communicate with each other via the private network 220 and the public network 222. For instance, the client-facing tier 202 can communicate with the application tier 204 and the acquisition tier 206 via the private network 220. The application tier 204 can also communicate with the acquisition tier 206 via the private network 220. Further, the application tier 204 can communicate with the acquisition tier 206 and the operations and management tier 208 via the public network 222. Moreover, the acquisition tier 206 can communicate with the operations and management tier 208 via the public network 222. In a particular embodiment, elements of the application tier 204, including, but not limited to, a client gateway 250, can communicate directly with the client-facing tier 202.

As illustrated in FIG. 2, the client-facing tier 202 can communicate with user equipment via a private access network 266, such as an Internet Protocol Television (IPTV) access network. In an illustrative embodiment, modems, such as a first modem 214 and a second modem 223 can be coupled to the private access network 266. The client-facing tier 202 can communicate with a first representative set-top box device 216 via the first modem 214 and with a second representative set-top box device 224 via the second modem 223. The client-facing tier 202 can communicate with a large number of set-top boxes, such as the representative set-top boxes 216, 224, over a wide geographic area, such as a regional area, a metropolitan area, a viewing area, a designated market area or any other suitable geographic area, market area, or subscriber or customer group that can be supported by networking the client-facing tier 202 to numerous set-top box devices. In an illustrative embodiment, the client-facing tier, or any portion thereof, can be included at a video head-end office.

In a particular embodiment, the client-facing tier 202 can be coupled to the modems 214, 223 via fiber optic cables. Alternatively, the modems 214 and 223 can be digital subscriber line (DSL) modems that are coupled to one or more network nodes via twisted pairs, and the client-facing tier 202 can be coupled to the network nodes via fiber-optic cables. Each set-top box device 216, 224 can process data received via the private access network 266, via an IPTV software platform, such as Microsoft® TV IPTV Edition. In another embodiment, representative set-top boxes 216, 224 can receive data from private access network 266 through RF and other cable and/or satellite based networks.

Additionally, the first set-top box device 216 can be coupled to a first external display device, such as a first television monitor 218, and the second set-top box device 224 can be coupled to a second external display device, such as a second television monitor 226. Moreover, the first set-top box device 216 can communicate with a first remote control 219, and the second set-top box device can communicate with a second remote control 228.

In an example, non-limiting embodiment, each set-top box device 216, 224 can receive video content, which may include video and audio portions, from the client-facing tier 202 via the private access network 266. The set-top boxes 216, 224 can transmit the video content to an external display device, such as the television monitors 218, 226. Further, the set-top box devices 216, 224 can each include a STB processor, such as STB processor 270, and a STB memory device, such as STB memory 272, which is accessible to the STB processor 270. In one embodiment, a computer program, such as the STB computer program 274, can be embedded within the STB memory device 272. Each set-top box device 216, 224 can also include a video content storage module, such as a digital video recorder (DVR) 276. In a particular embodiment, the set-top box devices 216, 224 can communicate commands received from the remote control devices 219, 228 to the client-facing tier 202 via the private access network 266.

In an illustrative embodiment, the client-facing tier 202 can include a client-facing tier (CFT) switch 230 that manages communication between the client-facing tier 202 and the private access network 266 and between the client-facing tier 202 and the private network 220. As shown, the CFT switch 230 is coupled to one or more image and data servers 232 that store still images associated with programs of various IPTV channels. The image and data servers 232 can also store data related to various channels, e.g., types of data related to the channels and to programs or video content displayed via the channels. In an illustrative embodiment, the image and data servers 232 can be a cluster of servers, each of which can store still images, channel and program-related data, or any combination thereof. The CFT switch 230 can also be coupled to a terminal server 234 that provides terminal devices with a connection point to the private network 220. In a particular embodiment, the CFT switch 230 can also be coupled to one or more video-on-demand (VOD) servers 236 that store or provide VOD content imported by the IPTV system 200. In an illustrative, non-limiting embodiment, the VOD content servers 280 can include one or more unicast servers.

The client-facing tier 202 can also include one or more video content servers 280 that transmit video content requested by viewers via their set-top boxes 216, 224. In an illustrative, non-limiting embodiment, the video content servers 280 can include one or more multicast servers.

As illustrated in FIG. 2, the application tier 204 can communicate with both the private network 220 and the public network 222. The application tier 204 can include a first application tier (APP) switch 238 and a second APP switch 240. In a particular embodiment, the first APP switch 238 can be coupled to the second APP switch 240. The first APP switch 238 can be coupled to an application server 242 and to an OSS/BSS gateway 244. In a particular embodiment, the application server 242 can provide applications to the set-top box devices 216, 224 via the private access network 266, which enable the set-top box devices 216, 224 to provide functions, such as display, messaging, processing of IPTV data and VOD material, etc. In a particular embodiment, the OSS/BSS gateway 244 includes operation systems and support (OSS) data, as well as billing systems and support (BSS) data. In one embodiment, the OSS/BSS gateway can provide or restrict access to an OSS/BSS server 264 that stores operations and billing systems data.

Further, the second APP switch 240 can be coupled to a domain controller 246 that provides web access, for example, to users via the public network 222. For example, the domain controller 246 can provide remote web access to IPTV account information via the public network 222, which users can access using their personal computers 268. The second APP switch 240 can be coupled to a subscriber and system store 248 that includes account information, such as account information that is associated with users who access the system 200 via the private network 220 or the public network 222. In a particular embodiment, the application tier 204 can also include a client gateway 250 that communicates data directly with the client-facing tier 202. In this embodiment, the client gateway 250 can be coupled directly to the CFT switch 230. The client gateway 250 can provide user access to the private network 220 and the tiers coupled thereto.

In a particular embodiment, the set-top box devices 216, 224 can access the IPTV system 200 via the private access network 266, using information received from the client gateway 250. In this embodiment, the private access network 266 can provide security for the private network 220. User devices can access the client gateway 250 via the private access network 266, and the client gateway 250 can allow such devices to access the private network 220 once the devices are authenticated or verified. Similarly, the client gateway 250 can prevent unauthorized devices, such as hacker computers or stolen set-top box devices from accessing the private network 220, by denying access to these devices beyond the private access network 266.

For example, when the first representative set-top box device 216 accesses the system 200 via the private access network 266, the client gateway 250 can verify subscriber information by communicating with the subscriber and system store 248 via the private network 220, the first APP switch 238, and the second APP switch 240. Further, the client gateway 250 can verify billing information and status by communicating with the OSS/BSS gateway 244 via the private network 220 and the first APP switch 238. In one embodiment, the OSS/BSS gateway 244 can transmit a query across the first APP switch 238, to the second APP switch 240, and the second APP switch 240 can communicate the query across the public network 222 to the OSS/BSS server 264. After the client gateway 250 confirms subscriber and/or billing information, the client gateway 250 can allow the set-top box device 216 access to IPTV content and VOD content. If the client gateway 250 cannot verify subscriber information for the set-top box device 216, e.g., because it is connected to an unauthorized twisted pair, the client gateway 250 can block transmissions to and from the set-top box device 216 beyond the private access network 266.

As indicated in FIG. 2, the acquisition tier 206 includes an acquisition tier (AQT) switch 252 that communicates with the private network 220. The AQT switch 252 can also communicate with the operations and management tier 208 via the public network 222. In a particular embodiment, the AQT switch 252 can be coupled to a live acquisition server 254 that receives television or movie content, for example, from content sources 256 through an encoder 255. In a particular embodiment during operation of the IPTV system, the live acquisition server 254 can acquire television or movie content. The live acquisition server 254 can transmit the television or movie content to the AQT switch 252 and the AQT switch 252 can transmit the television or movie content to the CFT switch 230 via the private network 220.

Further, the television or movie content can be transmitted to the video content servers 280, where it can be encoded, formatted, stored, or otherwise manipulated and prepared for communication to the set-top box devices 216, 224. The CFT switch 230 can communicate the television or movie content to the modems 214, 223 via the private access network 266. The set-top box devices 216, 224 can receive the television or movie content via the modems 214, 223, and can transmit the television or movie content to the television monitors 218, 226. In an illustrative embodiment, video or audio portions of the television or movie content can be streamed to the set-top box devices 216, 224.

Further, the AQT switch can be coupled to a video-on-demand importer server 258 that stores television or movie content received at the acquisition tier 206 and communicates the stored content to the VOD server 236 at the client-facing tier 202 via the private network 220. Additionally, at the acquisition tier 206, the video-on-demand (VOD) importer server 258 can receive content from one or more VOD sources outside the IPTV system 200, such as movie studios and programmers of non-live content. The VOD importer server 258 can transmit the VOD content to the AQT switch 252, and the AQT switch 252, in turn, can communicate the material to the CFT switch 230 via the private network 220. The VOD content can be stored at one or more servers, such as the VOD server 236.

When user issue requests for VOD content via the set-top box devices 216, 224, the requests can be transmitted over the private access network 266 to the VOD server 236, via the CFT switch 230. Upon receiving such requests, the VOD server 236 can retrieve the requested VOD content and transmit the content to the set-top box devices 216, 224 across the private access network 266, via the CFT switch 230. The set-top box devices 216, 224 can transmit the VOD content to the television monitors 218, 226. In an illustrative embodiment, video or audio portions of VOD content can be streamed to the set-top box devices 216, 224.

FIG. 2 further illustrates that the operations and management tier 208 can include an operations and management tier (OMT) switch 260 that conducts communication between the operations and management tier 208 and the public network 222. In the embodiment illustrated by FIG. 1, the OMT switch 260 is coupled to a TV2 server 262. Additionally, the OMT switch 260 can be coupled to an OSS/BSS server 264 and to a simple network management protocol (SNMP) monitor 270 that monitors network devices within or coupled to the IPTV system 200. In a particular embodiment, the OMT switch 260 can communicate with the AQT switch 252 via the public network 222.

In an illustrative embodiment, the live acquisition server 254 can transmit the television or movie content to the AQT switch 252, and the AQT switch 252, in turn, can transmit the television or movie content to the OMT switch 260 via the public network 222. In this embodiment, the OMT switch 260 can transmit the television or movie content to the TV2 server 262 for display to users accessing the user interface at the TV2 server 262. For example, a user can access the TV2 server 262 using a personal computer (PC) 268 coupled to the public network 222.

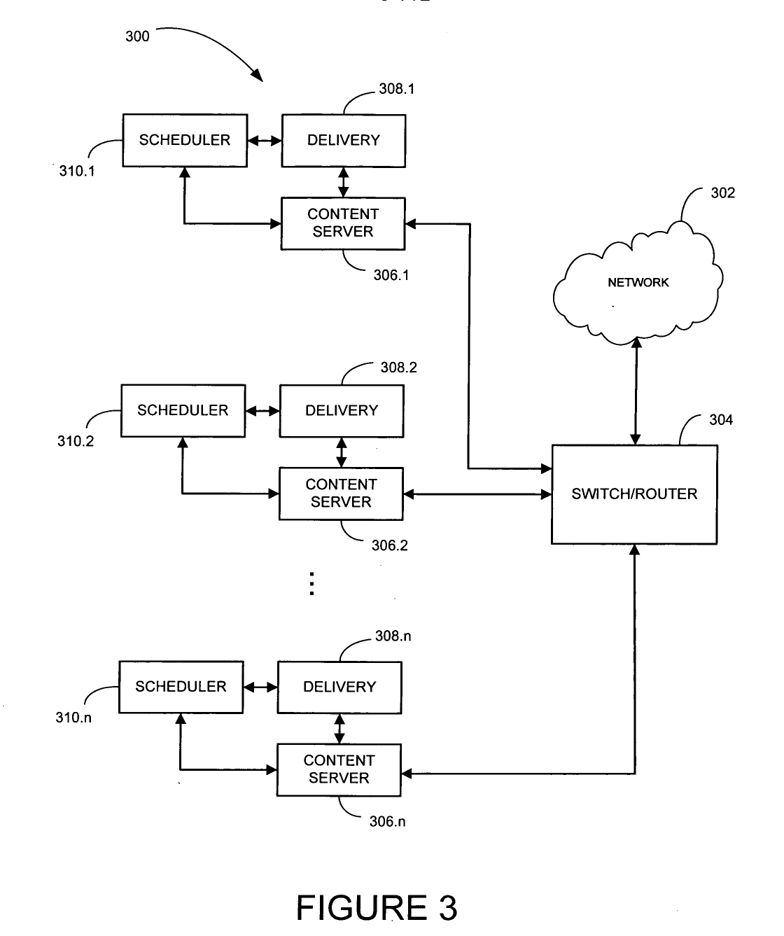

Referring to FIG. 3, an example embodiment of a system 300 for scheduling and delivering content through a network 302 is illustrated. The network 302 may include the network 104 (see FIG. 1).

A number of content servers 306.1-306.n may communicate through the network 302 through a switch/router 304. The content servers 306.1-306.n may access content to be transmitted to one or more intermediate devices 108.1, 108.2. The switch/router 304 may include the switch/router 103 (see FIG. 1). The content servers 306.1-306.n may include the VOD servers 236 (see FIG. 2), video content servers 280, digital music servers, data servers, information servers and the like. Each content server 306 may respectively be coupled to a scheduler module 310 and a delivery module 308.

The scheduler modules 310.1-310.n may respectively be coupled to the plurality of servers 406.1-406.n and the plurality of delivery modules 408.1-408.n. In an example embodiment, the scheduler modules 310.1-310.n may select content for scheduling and schedule the content for delivery.

One or more delivery modules 308.1-308.n may effectuate content delivery as respectively determined by the one or more scheduler modules 310.1-310.n. For example, the one or more delivery modules may effectuate delivery of the content via at least one transmission protocol to the one or more intermediate devices 108.1, 108.2 according to the schedule.

In an example embodiment, the at least one transmission protocol may include a multicast transmission protocol, a unicast transmission protocol or both the multicast transmission protocol and the unicast transmission protocol.

In an example embodiment, the one or more delivery modules 308.1-308.n may effectuate transmission of content through the network 104 by transmitting the content through the network 104. In an example embodiment, the one or more delivery modules 308.1-308.n may effectuate transmission of the content through the network 104 by directing the content servers 306.1-306.n to transmit the content through the network 104.

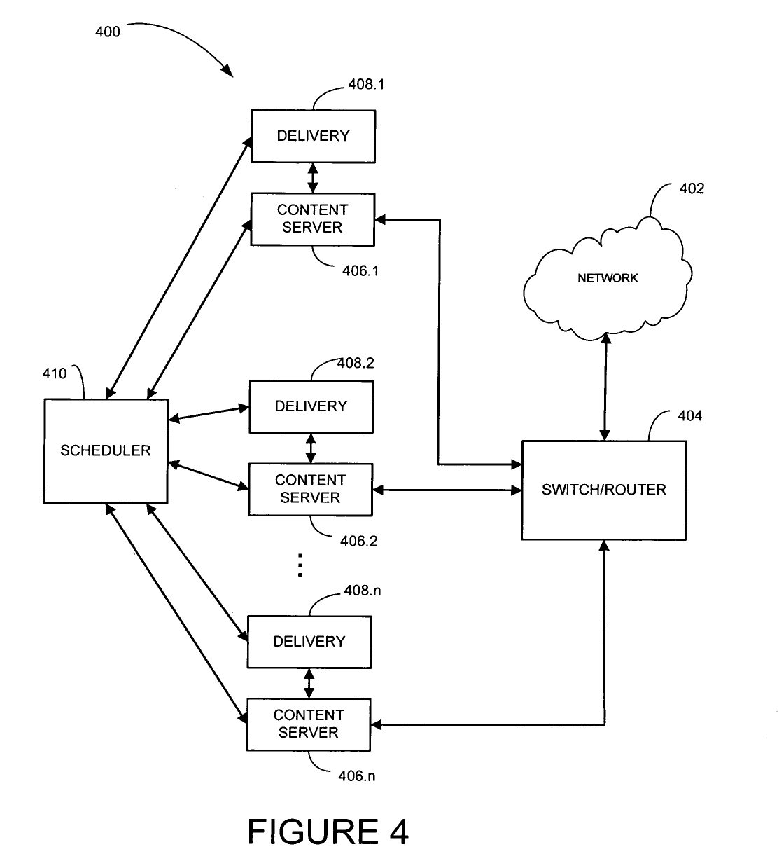

Referring to FIG. 4, an example embodiment of a system 400 for scheduling and delivering content through a network 402 is illustrated. The network 402 may include the network 104 (see FIG. 1).

A number of content servers 406.1-406.n may communicate over the network 402 through a switch/router 404. The switch/router 404 may include the switch/router 103 (see FIG. 1). The content servers 406.1-406 may include the content servers 306.1-306.n (see FIG. 3).

The content servers 406.1-406.n may respectively be coupled to a number of delivery modules 408.1-408.n. One or more delivery modules 408.1-408.n may effectuate content delivery as determined by a scheduler module 410.

The scheduler module 410 may be coupled to the plurality of servers 406.1-406.n and the plurality of delivery modules 408.1-408.n. In an example embodiment, the scheduler module 410 may select content for scheduling and schedule the content for delivery.

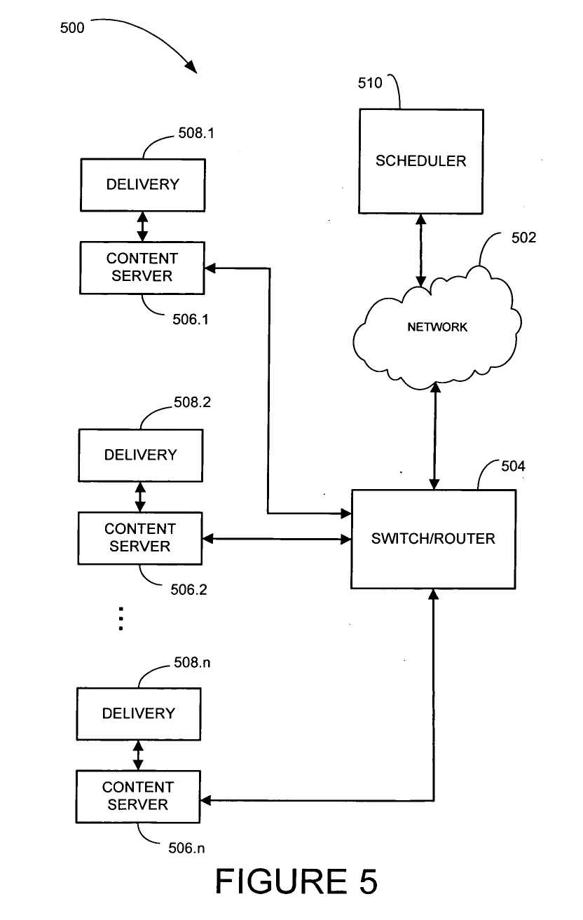

Referring to FIG. 5, an example embodiment of a system 500 for scheduling and delivering content through a network 502 is illustrated. The network 502 may include the network 104 (see FIG. 1).

A number of servers 506.1-506.n communicate over the network 502 through a switch/router 504. The switch/router 504 may include the switch/router 103 (see FIG. 1). The servers 506.1-506.n may respectively be coupled to a number of delivery modules 508.1-508.n. One or more delivery modules 508.1-508.n may effectuate content delivery as determined by a scheduler module 510.

The scheduler module 510 may be coupled to the plurality of servers 506.1-506.n and the plurality of delivery modules 508.1-508.n through the network 502. In an example embodiment, the scheduler module 510 may select content for scheduling and schedule the content for delivery.

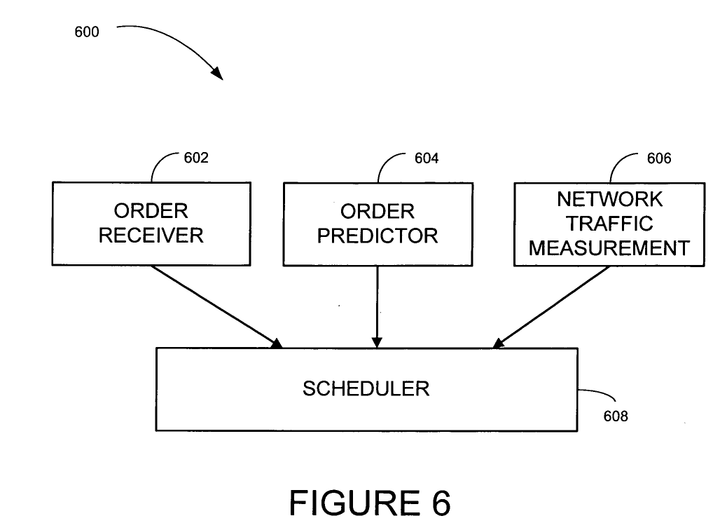

Referring to FIG. 6, an example embodiment of a system 600 for scheduling content is illustrated. The system 600 may include a scheduler module 608 for scheduling and schedule the content for delivery. The scheduler module 608 may include a scheduler module from the number of scheduler modules 310.1-310.n, 410, 510 (see FIGS. 3-5).

In an example embodiment, the scheduler module 608 may select content for scheduling through content aggregation. For example, content aggregation may include selecting the content should be provided to the intermediate devices 108.1, 108.2 (see FIG. 1) in advance of use of the content based on processing content requests received from the intermediate devices 108.1, 108.2 and/or content predictions made for the intermediate devices 108.1, 108.2. In an example embodiment, the scheduler module 608 may schedule the content for delivery over the network 104, 302, 402, 502 (see FIGS. 1 and 3-5) such as during a non-peak period. For example, the scheduler module 608 may create a schedule identifying when the content is to be delivered.

In an example embodiment, the scheduler module 608 may receive information from an order receiver module 602, an order predictor module 604 and a network traffic measurement module 606. For example, the information received by the scheduler module 608 from the order receiver module 602 and the order predictor module 604 may be used as scheduling factors for determining when the content that should be scheduled for delivery. The information received by the scheduler module 608 from the order receiver module 602, the order predictor module 604 and the network traffic measurement module 606 may be used to determine content selection and by what transmission protocol the content should be delivered. For example, the scheduling factors may include at least one of one or more processed content requests (e.g., a first selection), predicted content (e.g., a second selection), and weighing one or more processed content requests and predicted content.

In an example embodiment the scheduler module 608 may determine a first portion of the content to be sent via a multicast transmission protocol to one or more devices and a second portion of the content to be sent via a unicast transmission protocol to the one or more intermediate devices 108.1, 108.2 (see FIG. 1). For example, the first portion of the content may include content requested by and/or predicted for a larger number of intermediate devices 108.1, 108.2 while the second portion may include content requested by and/or predicted for a lesser number of intermediate devices 108.1, 108.2.

The order receiver module 602 may process content requests received, such as from the user devices 106.1-106.3 (see FIG. 1) or at the direction of users. For example, the content requests may be processed based on a historical ordering process, watching habits of one or more users and/or other information. In an example embodiment, the scheduler module 608 may include the content requests received from the order receiver module 602 as a selection of the content. In an example embodiment, the one or more processed content requests may be a scheduling factor for use by the scheduler module 608.

The order predictor module 604 may make content predictions as to the content or content type that is likely to be desired to be reproduced on the user devices 106.1-106.3. For example, the order predictor module 604 may determine predicted content based on a historical ordering process, watching habits of one or more users and/or other information. In an example embodiment, the scheduler module 608 may include a selection of the content based on an analysis of historical ordering and watching habits from the order predictor module 604. In an example embodiment, the content predictions as a result of an analysis of the historical ordering process, watching habits of one or more users and/or other information may be a scheduling factor for use by the scheduler module 608.

The network traffic measurement module 606 may determine network capability for providing the content, such as by identifying peak and non-peak periods. For example, the peak and non-peak periods may be identified by network congestion, peak traffic periods, when servers distributing the content are least utilized and the like. In an example embodiment, the non-peak period may include when network congestion of the network is low and/or the content servers distributing the content have available capacity.

In an example embodiment, the network traffic measurement module 606 may be coupled to the switch/router 103 (see FIG. 1) to measure traffic.

In an example embodiment, the scheduler module 608 may select a portion of the content for delivery. For example, the portion may be the entire portion or a partial of the content. In an example embodiment, the content selected by the scheduler module 608 for delivery may include the content indicated by the content requests and/or content predictions.

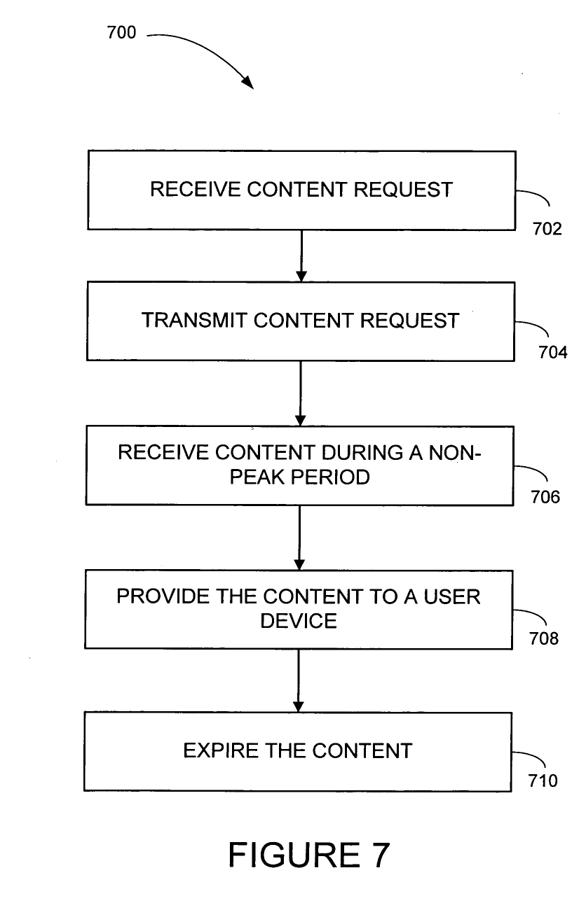

Referring to FIG. 7, a method 700 in accordance with an example embodiment for providing content in response to a content request is shown. The content request may be received at block 702. The content request may include information to retrieve the content, such as a name, a date and time, and/or a source of the content. In an example embodiment, the content request may be received on the intermediate devices 108.1, 108.2 from one or more of the plurality of user devices 106.1-106.n (see FIG. 1). In an example embodiment, the content request may be a request to view the content in advance of when the content will be reproduced (e.g., not in real-time or instantaneously) on a user device 106. For example, a user may request to view the content at least twenty-four or forty-eight hours before the content will be reproduced.

The content request may be transmitted at block 704. For example, the transmitted content request may be sent by one or more of the intermediate devices 108.1, 108.2 and received by the order receiver module 602 or the schedulers 304.1-304.n, 410, 510, 608 (see FIGS. 3-6).

The requested content may be received during a non-peak period at block 706. For example, the requested content may be received by the intermediate devices 108.1, 108.2. In an example embodiment, the requested content may be received only by the intermediate devices 108.1, 108.2 that requested the content. In an example embodiment, the requested content may be received by the intermediate devices 108.1, 108.2 that requested the content and by the intermediate devices 108.1, 108.2 that did not request the content.

In an example embodiment, the requested content may be received at a delay from an original transmission (e.g., not in real-time or instantaneously) of the content from a content source such as a content server.

In an example embodiment, the non-peak period may be determined by the network traffic measurement module 606 (see FIG. 6), such that the content reproduction may be subject to duplication and/or reproduction restrictions.

In an example embodiment, the non-peak period may be when the plurality of servers 306-1-306.n, 406.1-406.n, 506.1-506.n have a capacity remaining to handle additional content requests.

In an example embodiment, the content may be stored with digital rights management (DRM) at block 706.

The requested content may be provided to one or more of the plurality of user devices 106.1-106.n at block 708. For example, the non-networked intermediate devices 108.1 may provide the requested content to the user device 106.1, and the networked intermediate device 108.2 may provide the requested content to the number of user devices 106.2-106.n.

The content may expire at block 710. For example, the content may expire pursuant to business logic, such as only a certain portion or number of content portions may be stored on the intermediate devices 108.1, 108.2 and as additional content portions are received at block 706 an oldest or otherwise selected content portions may expire.

Upon completion of block 710, the method 700 may terminate.

In an example embodiment, the content received during the non-peak period at block 706 may be locked. For example, the content may be locked for a period of time on the intermediate devices 108.1, 108.2 such as to enable delivery of the content to the intermediate devices 108.1, 108.2 before the content may be available to the plurality of user devices 106.1-106.n.

In an example embodiment, the content may then be unlocked prior to providing the content at block 708. For example, the content may be unlocked by expiration of a period of time, by a user purchasing accessing to the content and the like.

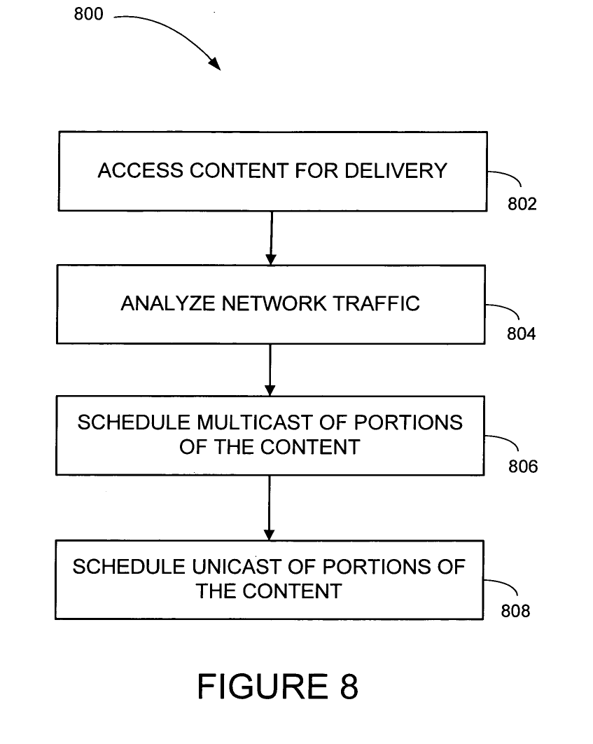

Referring to FIG. 8, a method 800 in accordance with an example embodiment for scheduling content is shown. Content for delivery may be accessed at block 802. For example, the content may include content identified by content requests and/or content predictions. Accessing the content may include accessing the content that has previously been stored.

At block 804, network traffic may be analyzed by conducting a network traffic analysis. Analysis of the network traffic may include determining peak and non-peak traffic periods for transmitting the content over the network 104, 302, 402, 502 (see FIGS. 1, 3-5).

One or more portions of the content may be scheduled for transmission with a multicast transmission protocol (e.g., a multicast transmission) at block 806. In an example embodiment, the multicast transmission may include transmission to more than one of the intermediate devices 108.1, 108.2. In an example embodiment, use of the multicast transmission to a segment of the plurality of the user devices 106.1-106.n of the content as opposed to the unicast transmission of the same content to the segment of the plurality of the user devices 106.1-106.n may reduce network bandwidth and server overhead.

In an example embodiment, the one or more portions may include at least one of a partial portion of the content and an entire portion of the content.

In an example embodiment, a determination may be made at block 806 as to a first section of the portion of the content for transmission via a multicast transmission protocol and a second section of the portion of the content for transmission via a unicast transmission protocol.

In an example embodiment, if more than one of the intermediate devices 108.1, 108.2 are to receive content, the content may be scheduled at block 806.

One or more portions of the content may be scheduled for transmission with a unicast transmission protocol (e.g., a unicast transmission) at block 808. In an example embodiment, the unicast transmission may include transmission to one of either of the intermediate devices 108.1, 108.2.

In an example embodiment, a schedule may be created by completing block 806 and/or block 808. In an example embodiment, the scheduling may include a transmission time of when to begin transmitting portions of the content according to the multicast transmission protocol and/or the unicast transmission protocol.

In an example embodiment, the content may be scheduled using block 806 to a limit of the server system 102 (see FIG. 1) and remaining content may be scheduled using block 808.

Upon completion of block 808, the method 800 may terminate.

In an example embodiment, block 802 and block 804 may occur in reverse order. In an example embodiment, block 806 and block 808 may occur in reverse order.

In an example embodiment, the method 800 may occur on one of the number of schedulers 310.1-310.n, or the scheduler module 410, 510 (see the FIGS. 3-5).

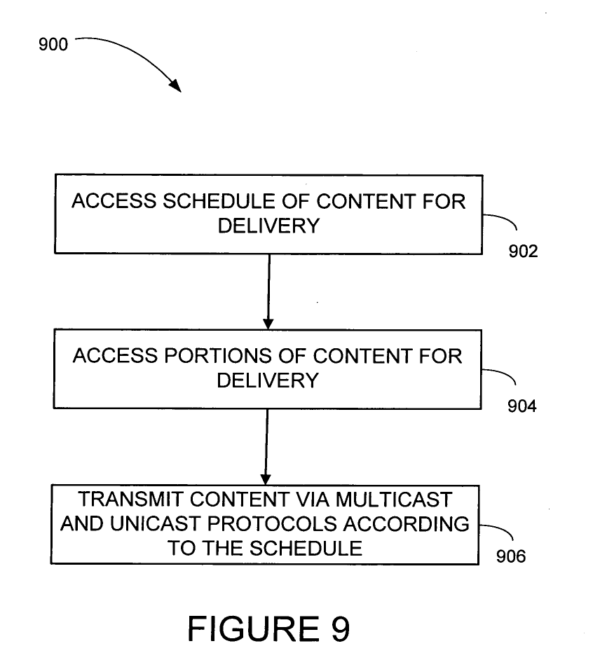

Referring to FIG. 9, a method 900 in accordance with an example embodiment for delivering content is shown. A schedule for delivery of content is accessed at block 902. In an example embodiment, the schedule may be generated during the method 800 (see FIG. 8). In an example embodiment, the method 900 may occur on the server system 102 (see FIG. 1).

In an example embodiment, the method 900 may be implemented on the delivery modules 308.1-308.n, 408.1-408.n, 508.1-508.n (see FIGS. 3-5). For example, one or more of the delivery modules 308.1-308.n, 408.1-408.n, 508.1-508.n may access the schedule from the schedule modules 310.1-310.n, 410, 510 at block 902.

Portions of the content may be accessed for delivery at block 904. In an example embodiment, the portions of the accessed content may be some or all of the content. In an example embodiment, the accessed portions of the content may be all of the content as indicated by the content requests and/or predicted content. Other embodiments for the accessed portions of the content are also contemplated.

The content may be transmitted via the multicast transmission protocol and/or the unicast transmission protocol according to the schedule at block 906. Upon completion of block 906, the method 900 may terminate.

In an example embodiment, the method 900 may operate continuously in a loop such that an updated schedule may continually be accessed.

In an example embodiment, the method 900 may operate on the delivery modules 308.1-308.n, 408.1-408.n, 508.1-508.n (see FIGS. 3-5).

In an example embodiment, the method 900 may operate on the content servers 306.1-306.n, 406.1-406.n, 506.1-506.n.

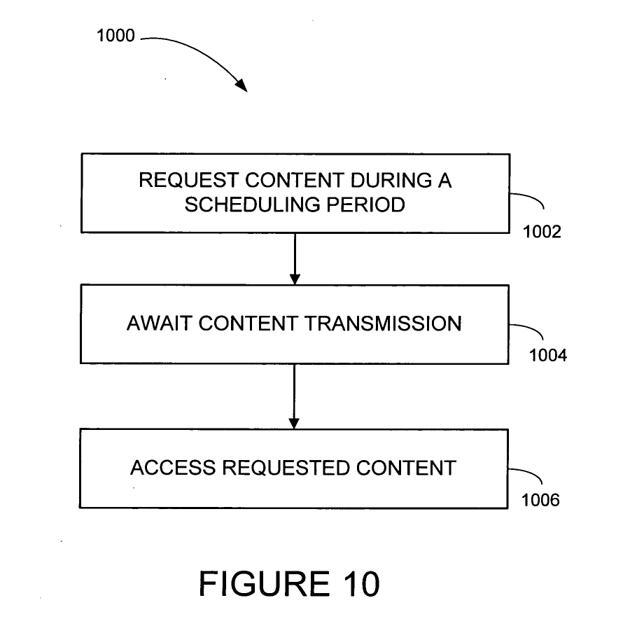

Referring to FIG. 10, a method 1000 in accordance with an example embodiment for requesting and accessing content is shown. A request for content may be made at block 1002 during a scheduling period. For example, the scheduling period may be a time period (e.g., twenty-four or forty-eight hours) before the content becomes available. In an example embodiment, the request for the content may be processed according to the method 700 (see FIG. 7).

At block 1004, the content transmission may be awaited. For example, the content may be transmitted according to the multicast transmission protocol or the unicast transmission protocol at block 906 (see FIG. 9). In an example embodiment, the requested content may not be immediately available. For example, the requested content may not be available until after a non-peak period occurs during which the requested content is transmitted.

The requested content may be accessed at block 1006. In an example embodiment, the requested content may be reproduced at a delay from operation of block 1002 such that the requested content is not immediately available for reproduction. In an example embodiment, the requested content may be reproduced at a delay from an original broadcast (e.g., not in real-time) of the requested content.

Upon completion of block 1006, the method 1000 may terminate.

In an example embodiment, the method 1000 may operate on the plurality of user devices 106.1-106.n.

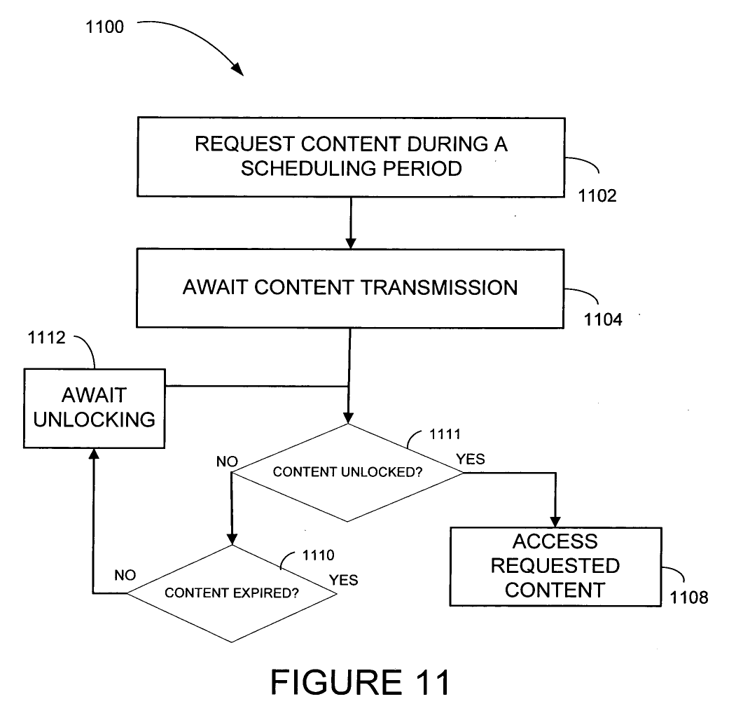

Referring to FIG. 11, a method 1100 in accordance with an example embodiment for requesting and accessing content is shown. A request for content may be made at block 1102 during a scheduling period. The scheduling period may include the scheduling period of the method 1000 (see FIG. 10). In an example embodiment, the request for the content may be processed according to the method 700 (see FIG. 7).

At block 1104, a transmission of the content may be awaited. In an example embodiment, the content transmission may occur during a non-peak period.

At decision block 1111, a determination is made as to whether the content is unlocked. For example, the content may be locked based on whether a particular user device 106 of the plurality of user devices 106.1-106.n is authorized to access the transmitted content, such that the transmitted content after transmission may not be made immediately available to the particular user device 106 (see FIG. 1).

If the content is unlocked, the method 1100 at block 1108 may access the content. For example, the accessing of the content may be in a manner described at block 1006 (see FIG. 10).

If the content is locked at decision block 1111, the method 1100 may determine whether the content is expired. For example, the content may be expired if a window of opportunity to view the content has concluded. If the content is not expired, unlocking of the content may be awaited at block 1112 before returning to decision block 1111. For example, the content may be first transmitted by the server system 102 and later made available for reproduction on the intermediate devices 108.1, 108.2 at a time determined by a provider of the content.

In an example embodiment, the content may be unlock at block 1112 by certain users of the user devices 106.1-106.n, such as by users with a proper verification of the security controls to access the content. For example, a parent may have access to the content with the proper verification while a child may not have proper verification of the security controls.

If the content is expired at decision block 1110 or after block 1108, the method 1100 may terminate.

In an example embodiment, if at decision block 1110 the content is expired, a user may be able to unexpire and unlock the content. For example, the user may pay a fee to a content provider or an operator of the server system 102 (see FIG. 1) to obtain access to the content.

In an example embodiment, the method 1100 may occur on the plurality of user devices 106.1-106.n.

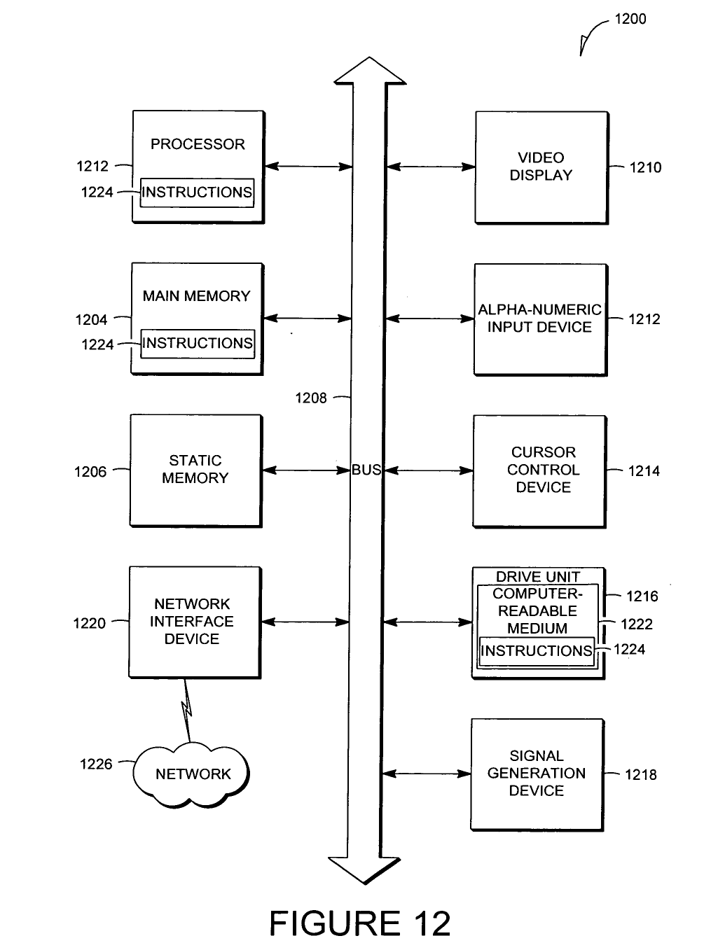

FIG. 12 shows a diagrammatic representation of machine in the example form of a computer system 1200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1212 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216 (e.g., a storage), a signal generation device 1218 (e.g., a speaker) and a network interface device 1220.

The disk drive unit 1216 includes a machine-readable medium 1222 on which is stored one or more sets of instructions and data structures (e.g., software 1224) embodying or utilized by any one or more of the methodologies or functions described herein. The software 1224 may also reside, completely or at least partially, within the main memory 1204 and/or within the processor 1212 during execution thereof by the computer system 1200, the main memory 1204 and the processor 1212 also constituting machine-readable media.

The software 1224 may further be transmitted or received over a network 1226 via the network interface device 1220 utilizing any one of a number of well-known transfer protocols (e.g., HTTP).

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A server system comprising:
a scheduler module to:
select content to be scheduled for delivery to a device in advance of use of the content based on processing at least one of content requests received from the device and content predictions made for the device, and
schedule the content for delivery over a network during a non-peak period;
a content server to access the content to be transmitted to the device; and
a delivering module to effectuate delivery of the content over the network via a transmission protocol to the device.

2. The system of claim 1, further comprising:
a receiver module to provide content requests to the scheduler module.

3. The system of claim 1, further comprising:
an order predictor module to provide content predictions to the scheduler module.

4. The system of claim 1, wherein the content include video content and the network includes a network of an Internet Protocol Television system.

5. The system of claim 1, wherein the transmission protocol includes a multicast transmission protocol.

6. The system of claim 1, wherein the device includes an intermediate device.

7. The system of claim 1, wherein the content includes at least one of video content, digital music content, data content and informational content.

8. The system of claim 1, wherein the non-peak period includes at least one of when network congestion of the network is low or the content server distributing the content has available capacity.

9. The system of claim 1, wherein the network includes a network of an Internet Protocol Television system, wherein the transmission protocol includes a multicast transmission protocol, wherein the device includes an intermediate device, and wherein the content includes at least one of video content, digital music content, data content and informational content.

10. An apparatus comprising:
a processor configured to:
include content requests as a first selection of content,
include content predictions as a second selection of the content; and
select a portion of the content to deliver by a multicast transmission protocol based on an analysis of the first and the second selection of the content.

11. The apparatus of claim 10, wherein the portion of the content includes at least one of a partial portion of the content and an entire portion of the content.

12. The apparatus of claim 10, wherein the portion of the content includes a partial portion of the content.

13. An apparatus comprising:
a processor configured to:
transmit a content request for content;
receive the content via a multicast transmission protocol during a non-peak period in response to the content request; and
a storage to retain the content.

14. The apparatus of claim 13, wherein the processor is further configured to:
provide the content to one or more user devices; and
expire the content.

15. The apparatus of claim 13, where the processor is further configured to:
restrict access to the content.

16. A method comprising:
analyzing network traffic of a network; and
scheduling delivery of at least a portion of video content of an Internet Protocol Television system through the network via a transmission protocol based on the network traffic analysis.

17. The method of claim 16 further comprising:
determining a portion of the video content to be scheduled according to one or more scheduling factors.

18. The method of claim 17, wherein the one or more scheduling factors includes at least one of one or more processed content requests, predicted content, and weighing one or more processed content requests and predicted content.

19. The method of claim 17 further comprising:
transmitting the video of the video content via multicast transmission protocol.

20. The method of claim 17, wherein analyzing network traffic includes determining peak periods and non-peak periods and further comprising:
transmitting the portion of the content via a multicast transmission protocol during the non-peak traffic periods.

21. The method of claim 17 further comprising:
determining a first section of the portion of the content for transmission via a multicast transmission protocol and determining a second section of the portion of the content for transmission via a unicast transmission protocol.

22. A method comprising:
receiving a number of requests for video content; and
transmitting the content via a multicast transmission protocol in response to the number of requests for video content during a non-peak period to a plurality of devices.

23. The method of claim 22, further comprising:
selecting a plurality of intermediate devices as the plurality of devices; and
receiving and storing the content.

24. A machine-readable medium comprising instructions, which when executed by a machine, cause the machine to:
analyze network traffic of a network; and
schedule delivery of at least a portion of video content of an Internet Protocol Television system through the network via a transmission protocol based on the network traffic analysis.

25. The machine-readable medium of claim 24, further comprising instructions, which when executed by a machine, cause the machine to:
include content requests as a first selection of video content;
include content predictions as a second selection of the video content; and
select a portion of the content to deliver by a multicast transmission protocol based on an analysis of the first and the second selection of the video content.

26. The machine-readable medium of claim 25, further comprising instructions, which when executed by a machine, cause the machine to:
transmit the portion of the content via a multicast transmission protocol during a non-peak period to a plurality of devices.
